(19) United States
(12) Patent Application Publication
(10) Pub. No.: US 2011/0048920 A1
(43) Pub. Date: Mar. 3, 2011

(54) Adsorbent - Adsorbate Desalination Unit and Method

(75) Inventors: Randall N. Avery, Bogart, GA (US); Charlie Booth, Watkinsville, GA (US)

(73) Assignee: Industrial Idea Partners, Inc.

(21) Appl. No.: 12/550,290

(22) Filed: Aug. 28, 2009

(51) Int. Cl. C02F 1/04; F25B 27/00; F25B 17/00; F25B 15/00

(52) U.S. Cl. 203/10; 62/238.3; 62/478; 62/485; 202/183; 202/177

(57) ABSTRACT

An adsorption-desalination unit utilizing a silica gel—water working pair adsorbent—adsorbate having an economizing heat exchanger to pre-heat the incoming source seawater to be desalinated in an evaporator from about 8° C. to about 1° C. above the ambient seawater temperature. The economizing heat exchanger employs heat captured during the adsorption cycle to pre-heat incoming source seawater, thereby increasing the efficient use of energy in the unit. The heating fluid utilized to drive the desorption cycle is further utilized to heat the evaporator. A mist eliminator positioned intermediate the evaporator and the adsorbent heat exchanger chambers prevents non-vaporized water from entering the adsorbent heat exchanger chambers.

### FIELD OF THE INVENTION

The present invention relates generally to a device and method for the desalination of seawater, and in particular to an improved adsorbent—adsorbate desalination unit optimized for use in the desalination of seawater.

The present invention utilizes an economizing heat exchanger situated outside the pressure vessel of an adsorption device utilizing a silica gel—water working pair adsorbent—adsorbate. The economizing heat exchanger utilizes the heat produced by the adsorption/desorption process to pre-heat the incoming source water to be desalinated, thus increasing the efficiency of the process over the prior art.

The introduction of the seawater to be desalinated into the evaporator at an elevated temperature relative to the seawater's ambient temperature greatly enhances the evaporation process, resulting in an increase of the efficiency of the desalination device over prior adsorption-desalination units.

The present invention also utilizes the water leaving the adsorption heat exchanger chamber during desorption to heat the evaporator heat exchanger to increase the efficiency of vaporization of the source seawater.

The present invention also utilizes a mist eliminator intermediate the evaporator and the adsorbent heat exchanger chambers to facilitate efficient vaporization of the source seawater without fouling of the adsorption-desalination unit.

### BACKGROUND OF THE INVENTION

Existing desalination technology uses significant energy to separate sea-salt from seawater. The two commercially available processes are thermal desalination and reverse osmosis desalination. Both of these technologies are widely used.

Thermal desalination uses large amounts of heat to vaporize seawater. The vaporized water is run through a heat exchanger where the phase reversal to distillate occurs.

In reverse osmosis desalination, large amounts of electrical energy drive seawater at high pressure through reverse osmosis membranes to separate ions from the water to produce a concentrated seawater and permeate of fresh water.

The present invention relates to the use of an adsorption process for the desalination of seawater. WIPO Application No. PCT/SG2006/000157 (“WIPO '157”) discloses a water desalination system comprising an evaporator for evaporating saline water to produce water vapor; an adsorption means in selective communication with the evaporator for reversibly adsorbing the water vapor from the evaporator; said adsorption means in selective vapor communication with a condenser; and desorbing means for desorbing the adsorbed water vapor from the adsorption means for collection by the condenser; said condenser adapted to condense the water vapor to desalinated water. However, the device and process disclosed in WIPO '157 embodies several inefficiencies that are rectified in the current invention. For example, the process described in WIPO '157 is inefficient because it utilizes only a cooling tower as the source of cooling-water to cool the adsorbent. Also, chilled water is produced in the evaporator which does not optimize the vaporization of the source seawater.

The invention of the present disclosure provides an additional method of cooling the fluid used to cool the adsorbent during the adsorption cycle. As it is routed through an economizing heat exchanger, the source seawater is used to cool the fluid used to cool the adsorbent during the adsorption cycle. Further the heat from the adsorbent is, in turn, used to warm the source seawater to be desalinated, enhancing its vaporization energy. This disclosure also includes a method of using the heat remaining in the water leaving the adsorption heat exchanger to heat the evaporator to increase the efficiency of the source seawater. Finally, this disclosure also includes a tortured path mist eliminator to avoid contamination of the adsorbent by the seawater.

Seawater temperatures vary considerably based primarily upon the season and the latitude of the location. For the purpose of this disclosure, we expect that the seawater near population centers might range from about 5° C. (41° F.) to about 30° C. (86° F.). For the sake of discussion and illustration purposes only, and not intended as a limitation, this disclosure will use an example source seawater temperature of 15° C. (60° F.) in the description of the present invention and its function. It should be recognized, however, that a wide range of source seawater temperatures may be utilized in connection with the present invention.

### SUMMARY OF THE INVENTION

The present invention relates to an improved, efficient method and device for the desalination of seawater using a switchable cycle adsorption-desorption process using an adsorbent/adsorbate working pair such as silica-gel and water. A novel aspect of the invention is the transference of the isosteric heat of adsorption generated in the adsorption cycle to the incoming source seawater to be distilled. The economizing heat exchanger uses heat from the adsorption cycle to raise or increase the temperature of the incoming seawater a total of between about 8° C. (14.4° F.) to about 18° C. (32.4° F.) above the temperature at which it enters or is input into the economizing heat exchanger. For example, the economizing heat exchanger of the present invention raises seawater input at an ambient temperature of 15° C. (60° F.) to between about 23° C. (73.4° F.) and about 33° C. (91° F.) before it is injected into the evaporator to begin the desalination process.

The present invention relates to an adsorption-desalination unit providing improved efficiencies over prior adsorption-desalination units through the use of an economizing heat exchanger to remove the heat accumulated in the cooling-water circuit and transfer that heat to the incoming seawater to be desalinated. By the same process, the temperature of the fluid in the cooling-water circuit is lowered by between about 5° C. (11.3° F.) to about 13° C. (23.4° F.) as it passes through the economizing heat exchanger. This cooling reduces the overall demand for external cooling of the fluid in the cooling-water circuit.

A further novel aspect of the present invention is the utilization of the heat remaining in the hot water after it powers the desorption cycle. As hot water exits the evaporator heat exchanger in the desorption cycle, the present invention transfers the latent heat remaining in the water to heat the evaporator heat exchanger. The addition of heat to the evaporator heat exchanger increases the efficiency of vaporization of the incoming source seawater to be distilled. The addition of waste heat from the desorption cycle to raise or increase the efficiency of the evaporator will result in increased vaporization of the incoming seawater a total of between about 20%-40% above that expected from the process described in WIPO '157.

To combat potentially undesirable effects that may result from injecting pre-heated seawater into a heated evaporator, a tortured-path mist eliminator is also used intermediate the evaporator and the adsorbent heat exchanger chambers.

It is therefore an object of the present invention to provide an improved water desalination system. The water desalination system of the present invention is optimized to more efficiently utilize the heating and cooling capacities of an adsorption/desorption process.

### BRIEF DESCRIPTION OF THE DRAWINGS

The particular features and advantages of the invention as well as other objects will become apparent from the following description taken in connection with the accompanying drawings in which:

FIG. 1 is a schematic drawing of the adsorption-desalination unit of the present invention.

FIG. 2 is a schematic drawing of an alternate, single-cycle adsorption-desalination unit according to the present invention.

### DETAILED DESCRIPTION OF THE PREFERRED EMBODIMENT

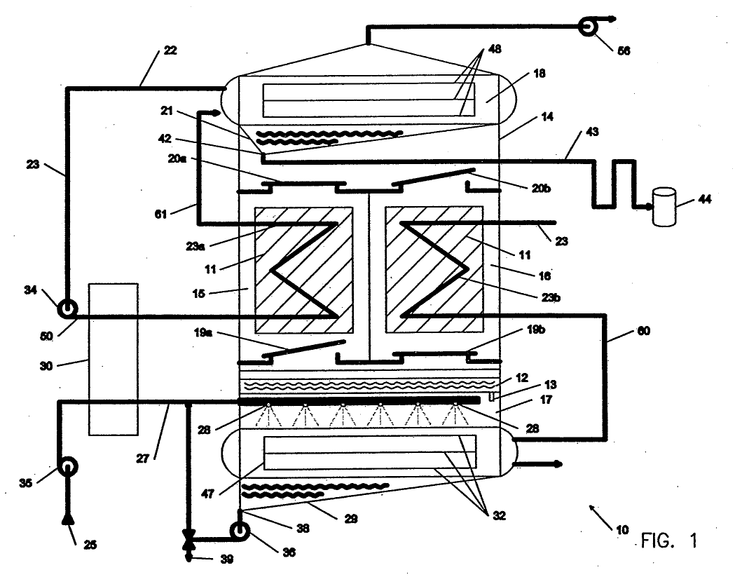

FIG. 1 is a schematic drawing of a preferred embodiment of the adsorption-desalination unit 10 of the present invention. The adsorption-desalination unit 10 uses an adsorbent 11 which can be regenerated. The presently preferred adsorption means is a silica gel—water working pair adsorption device. The presently preferred adsorbent is a silica gel, though other adsorbents may be useful in the adsorption means. The present invention uses water vapor generated from the source seawater or brine to be desalinated as the adsorbate.

The adsorption-desalination unit 10 of the present invention offers improved efficiencies over prior adsorption-desalination units through the use of an economizing heat exchanger 30, the injection of pre-heated seawater into an evaporator chamber 17, utilization of waste heat from the desorption cycle to heat the evaporator, and a mist eliminator 12.

An adsorption-desalination unit 10 comprises in principle a pressure vessel 14 divided into a plurality of chambers, at least one, but commonly a pair (two) or more of adsorbent heat exchanger chambers 15, 16 located between or positioned intermediate an evaporator chamber 17 containing an evaporator 47 and an upper condenser chamber 18 containing a condenser 48. The evaporator chamber 17 is typically located below the adsorbent heat exchanger chambers 15, 16, and the condenser chamber 18 is typically located above the adsorbent heat exchanger chambers 15, 16, though alternate arrangements are within the contemplation of this invention. The adsorbent heat exchanger chambers 15, 16 are each connected to the condenser chamber 18 and evaporator chamber 17 by one or more valves 19a, 19b and 20a, 20b, respectively.

The adsorption-desalination unit 10 of the present invention further comprises a fluid circulation system 22 comprising interconnected tubing or piping to carry fluid to the different chambers 15, 16, 17, 18. Appropriate valves in the circulation system 22 are provided to selectively direct relatively hot and relatively cold fluid (typically water) through different sections or portions of the fluid circulation system 22 in the appropriate sequence to drive the adsorption process. Fluid circulation system 22 comprises adsorption heat exchanger circuit 23, cooling-water circuit 61, and evaporator-heating circuit 60. Adsorption heat exchanger circuit 23 comprises portions 23a, 23b passing through adsorbent heat exchanger chambers 15 and 16, respectively. Cooling-water circuit 61 passes through the condenser chamber 18 to drive the condenser 48. Evaporator-heating circuit 60 passes through the evaporator chamber 17 to drive the evaporator 47. Fluid circulation system 22 further comprises an economizing heat exchanger loop 50 for passing fluid through an economizing heat exchanger 30. The economizing heat exchanger loop 50 comprises a portion of the cooling-water circuit 61 and is also interconnected with the adsorption heat exchanger circuit 23.

Many alternative plumbing layouts with various configurations of tubing and valves are well known in the adsorption art, and their use is within the contemplation of the present invention. To practice the present invention, the plumbing must be suitable for directing hot water through one of the adsorbent heat exchanger chambers 15 or 16 and evaporator 47 while directing cooling water through the economizing heat exchanger 30 and the other adsorbent heat exchanger chamber 15 or 16 and, alternatively, the condenser 48, and for the flows of hot and cooling water to the adsorbent heat exchanger chambers 15 and 16 to be switchable.

The fluid circulation system 22 further comprises a pumping means for moving the fluid through the circuit. Pumping means may comprise one or more pumps 34.

The portions 23a, 23b of adsorption heat exchanger circuit 23 within adsorbent heat exchanger chambers 15, 16 are surrounded by or packed with an adsorbent 11, preferably silica gel.

The incoming or source solution to be desalinated, such as seawater or brine, is carried, such as by a pumping means like pump 35, from a source 25, which may be the ocean, a storage tank (not shown) or any other source of brine, through an inlet line 27 and into the evaporator chamber 17. The brine is introduced into the evaporator chamber 17 where it is evaporated into a pure or distilled water vapor, leaving behind the salt and other impurities in a more concentrated brine. To increase the rate of evaporation across the evaporator tubes 32 of the evaporator 47, the solution to be desalinated is preferably dispersed throughout the evaporator chamber 17 by dispersing means, such as a series of spray nozzles 28.

The concentrated brine in the evaporator chamber 17 is collected in a collection area 29. The concentrated brine may then be removed through a vacuum trap or other pressure-maintaining drain 38 designed to allow removal of the concentrate without significantly changing the water vapor pressure within the evaporator chamber 17. The concentrated heated brine is directed, such as by a pumping means like pump 36, through appropriately plumbed tubing, either back into inlet line 27, thereby providing an additional source of pre-heating of the incoming solution, or, alternately, to a waste outlet 39. A portion of the concentrated heated brine must be dumped periodically to prevent super-saturation of the solution and formation of insoluble solid deposits on the evaporator tubes 32.

In a preferred embodiment, a mist eliminator 12 is interposed between the evaporator chamber 17 and the adsorbent heat exchanger chambers 15, 16, preferably between the evaporator 47 and the valves 19a, 19b that communicate between the evaporator chamber 17 and the adsorbent heat exchanger chambers 15, 16. The mist eliminator 12 functions to prevent passage of water droplets from the evaporator chamber 17 into the adsorbent heat exchanger chambers 15, 16 and to collect water droplets from the air and vapor stream and divert the liquid to an appropriate drain 13 for return to the evaporator 12. The mist eliminator also functions as a low-efficiency particulate filter. A mist eliminator 12 provides a large surface area in a small volume to collect liquid without substantially impeding air or vapor flow. Unlike filters, which hold particles indefinitely, mist eliminators 12 coalesce (merge) fine droplets and allow the liquid to drain away.

Mist eliminator 12 may comprise any number of physical structures known in the art for creating a tortured path for an air stream to follow, thereby providing ample surface areas upon which water droplets in the air stream can collect. The results achieved by a mist eliminator will depend on proper specification of mist eliminator type, such as mesh, vane or fiber bed (or a combination of types), orientation, thickness, internal details, support and spacing in the vessel, vapor velocity and flow pattern, and many other considerations. The mist eliminator 12 of the present invention may be designed in one or more elements or screens for easy removal from the pressure vessel 14 through a pressure-sealed opening (not shown) for cleaning or replacement.

When the adsorption-desalination unit 10 is first started, the pressure vessel 14 is evacuated to create a vacuum using an evacuation pump 56. Once started, an adsorption-desalination unit 10 operates automatically on a four step cycle. In a desorption cycle, hot water is introduced into one of the adsorbent heat exchanger chambers (shown as 16 in FIG. 1) through heat exchanger circuit portion 23b. This heating of the silica gel 11 forces water within the gel 11 into vapor (desorption), raising the water vapor pressure within the chamber 16 which, in turn, pushes open one-way valve 20b (and keeps one-way valves 19b and 20a closed). The difference in water vapor pressures between adsorbent heat exchanger chamber 16 and condenser chamber 18 creates an air flow or draw of air and the water vapor in chamber 16 moves through the valve 20b and into the condenser chamber 18.

Water vapor in the condenser chamber 18 contacts the condenser 48 which condenses the vapor back into pure desalinated water. This potable water is then collected in a collecting area or condenser well 21 and removed through a vacuum trap 42 or other pressure-maintaining drain and passed through an outlet line 43 to a storage tank 44 or other end use.

When the drying of the adsorbent 11 in the adsorbent heat exchanger chamber 16 is complete, in a first switching cycle, the water flowing through the adsorbent heat exchanger circuit 23b is switched from hot water to cooling water by means of conventional plumbing such as by the appropriate manipulation of a plurality of control valves, manifolds and pumps (not shown). Typically conventional plumbing is located outside of the pressure vessel 14 of the adsorption-desalination unit 10. A programmable logic control system or computer (not shown) may be employed to control the positions and timing of the control valves and manifolds of the plumbing.

This begins the adsorption cycle. Cool, dry silica gel 11 has a large affinity to capture water vapor and will capture all of the available water vapor from the adsorbent heat exchanger chamber 16, reducing the pressure in this chamber, closing valve 20b and allowing the valve 19b to be opened by the pressure of the water vapor being generated by the evaporator 47.

Water evaporates in a vacuum at room temperature and thereby extracts heat from its surroundings. The evaporation of seawater introduced into the evaporator chamber 17 cools the water flowing through the evaporator tubes 32 in the evaporator-heating circuit 60. The output of this water in the evaporator-heating circuit 60 is returned to the heat source (not shown) for heating and re-routing for the next desorption cycle.

In FIG. 1, adsorbent heat exchanger chamber 15 is illustrated as being in the adsorption cycle. The evaporated water passes through a mist eliminator 12 and an open or communicating, one-way valve 19a into adsorbent heat exchanger chamber 15 and is adsorbed into the adsorbent silica gel 11. Cool water is circulated in this chamber 15 through the adsorption heat exchanger circuit 23a to remove the heat generated by the isosteric heat of adsorption in this chamber 15. The adsorption process creates a slight decrease in pressure, creating a small vacuum differential between the evaporator chamber 17 and adsorbent heat exchanger chamber 15 that pulls water vapor from the evaporator 17 through valve 19a and into the adsorbent heat exchanger chamber 15. This decrease in pressure in adsorbent heat exchanger chamber 15 also pulls one-way valve 20a closed.

When adsorbent heat exchanger chamber 15 is in the adsorption cycle, adsorbent heat exchanger chamber 16 is in the desorption cycle, and vice versa; water in chamber 16 that has been adsorbed into the adsorbent 11 is driven from the adsorbent 11 by the circulation of hot water through the portion 23b of adsorbent heat exchanger circuit 23 running through chamber 16. The desorbed water vapor rises and exits adsorbent heat exchanger chamber 16 through opened valve 20b, entering the condenser 18 where it is condensed by the cool water circulating through the cooling-water circuit 61. As will be explained in more detail below, it is important to note that the cool water in the cooling-water circuit 61 gains heat through the condensing process. The cool water has also gained heat as it was run through the portion 23a of the adsorbent heat exchanger circuit 23 running through the chamber 15 in the adsorption cycle. The present invention is specially configured to take novel advantage of this heat in the economizing heat exchanger 30. Similarly, it is important to note that while the hot water circulated through the portion 23b of adsorbent heat exchanger circuit 23 loses heat through the desorption process, it still retains some residual heat when it exits the adsorbent heat exchanger chamber 16 in which the desorption cycle is occurring. Rather than simply returning this water to the heat source for reheating, the present invention is specially designed to take advantage of the residual heat in this water by routing it to the evaporator-heating circuit 60 where it is utilized to help heat the evaporator 47.

When an adsorbent heat exchanger chamber 15 is in the adsorption cycle, the pressure in that chamber 15 is slightly lower than in the evaporator chamber 17, accordingly, a portion of the seawater to be desalinated evaporates and is pulled into the adsorbent heat exchanger chamber 15. At the same time, the pressure in the other adsorbent heat exchanger chamber 16 in the desorption cycle, is slightly elevated as the water vapor is driven from the silica gel 11. That desorbed water vapor is pulled into the condenser chamber 18 which has a lower pressure as vapor in that chamber 18 is being condensed back into water.

When the silica gel 11 in the adsorption cycle chamber 15 is saturated with water and the silica gel 11 in the desorption cycle chamber 16 is dry, the programmable logic control system of the adsorption-desalination unit 10 automatically switches the adsorbent heat exchanger chambers 15 and 16 between adsorbing and desorbing cycles by exchanging the flows of hot and cool water. In one of two switching cycles, the flow of hot water through the adsorption heat exchanger circuit 23 is switched from flowing through the portion 23b of the adsorbent heat exchanger chamber 16 to flowing through the portion 23a to begin the desorption process in adsorbent heat exchanger chamber 15. Cool water that was running through the portion 23a of the adsorbent heat exchanger chamber 15 is switched to flow through portion 23b of adsorbent heat exchanger chamber 16 to begin the adsorption process. Valves 19a, 19b, 20a and 20b are preferably one-way valves which are actuated to their opposite condition (i.e., opened or closed) based upon changes in the water vapor pressure differentials in the chambers on opposing sides of the valves. For example, when heat exchanger chamber 16 is in the desorption cycle, valve 20b is pushed open by the increase in water vapor pressure within heat exchanger chamber 16 due to the desorption of water from the gel 11, but valve 19b is held closed by this same pressure. As an adsorption cycle begins in heat exchanger 16, the adsorption of water from the vapor creates a partial vacuum which pulls closed the valve 20b between the adsorption cycle chamber and the condenser chamber 18 but pulls open the valve 19b between the evaporator chamber 17 and heat exchanger chamber 16, thereby allowing for the proper flow of vapor through the adsorption-desalination unit 10. Thus it can be seen that the adsorption-desalination unit 10 requires only the switching of the flow of hot and cool water to function, but does not otherwise require the application of any external power source to drive the functioning of the valves 19a, 19b, 20a and 20b.

Once put into operation, an adsorption-desalination unit 10 operates continuously, switching the adsorption and desorption cycles between the available adsorbent heat exchanger chambers 15, 16. The invention is scalable; adsorption-desalination units 10 having a plurality of adsorbent heat exchanger chambers may increase the volume of seawater that can be desalinated during each cycle.

An adsorption-desalination unit 10 is capable of operating with a wide range of temperatures for the hot, the cool and the cold water. Cycles are generally run for pre-determined amounts of time, depending on the conditions presented, such as pressure, temperature, size and number of adsorbent heat exchanger chambers, amount and nature of adsorbent in the adsorbent heat exchanger chambers, and other factors known in the art. In a presently preferred embodiment, peak performance is obtained when the hot water used in the desorbing cycle to run through portion 23b of the adsorption heat exchanger circuit 23 is about 90° C. (194° F.), and the cooling water used in the adsorbing cycle to run through portion 23a of the adsorption heat exchanger circuit 23 is as cool as possible, perhaps as cool as about 21° C. (70° F.) when the incoming source seawater is at a temperature of about 15° C. (60° F.).

A novel feature of the present invention is the pre-heating of the incoming brine by means of an economizing heat exchanger 30. At the source 25, seawater or brine will be at the ambient seawater temperature, assumed, for discussion purposes, to be about 15° C. (60° F.), and might, depending on the weather, geographic location and other influencing factors, be introduced into the inlet line 27 having a temperature between about 5° C. (40° F.) to about 30° C. (86° F.). Rather than pre-heating the incoming brine using an external source of heat, the inlet line 27 passes the incoming seawater through an economizing heat exchanger 30. The economizing heat exchanger 30 of the present invention raises the temperature of the incoming brine by transferring to it the isosteric heat of adsorption from the adsorbent 11 or the heat of condensation from the condenser 48, or, preferably, both. This is accomplished by directing all or a portion of the fluid output from the adsorbent heat exchanger chambers 15 or 16 in the adsorption cycle and the condenser 48 through the economizing heat exchanger 30. The economizing heat exchanger 30 utilizes the isosteric heat of adsorption gained by the fluid during the adsorption cycle and the heat of condensation from the condenser 48 to increase the temperature of the incoming seawater from the source 25 from between about 8° C. (14.4° F.) to about 18° C. (32.4° F.) above its ambient temperature before it is introduced or injected into the evaporator 47. As an example for illustration purposes only and not as a limitation, source seawater input into the economizing heat exchanger 30 at about 15° C. (60° F.) is raised to approximately 23° C. (74° F.) before it is introduced into the evaporator chamber 17.

As part of this heat transfer within the economizing heat exchanger 30, the temperature of the cooling-fluid from the cooling-circuit input into the economizing heat exchanger 30 is decreased before it is output into the portion 23a or 23b of the adsorption heat exchanger circuit 23 driving the adsorption cycle at that time. The economizing heat exchanger 30 reduces the temperature of the fluid in the cooling-water circuit by between about 5° C. (11.3° F.) to about 13° C. (23.4° F.) as it passes through the economizing heat exchanger. Continuing the example based on source seawater at 15° C. (60° F.), the cooling-water would be cooled from about 40.5° C. (105° F.) to about 29.4° C. (85° F.).

Preferably, all or a portion of the fluid output from the adsorbent heat exchanger chamber 15 or 16 in the adsorption cycle is passed through the condenser 48 via the cooling-water circuit 61 prior to being passed into and through the economizing heat exchanger 30 via the economizing heat exchanger loop 50. This allows the fluid from the adsorption cycle to gain further heat as it passes through the condenser 48, and this heat, together with the heat of adsorption can then be transferred through the economizing heat exchanger 30 into the incoming source seawater to be desalinated.

Any type of heat exchanger providing efficient heat transfer from one fluid medium to another is suitable for the economizing heat exchanger 30 of the present invention. The presently preferred economizing heat exchanger 30 for use in the present invention is a flat plate type heat exchanger.

The utilization of an economizing heat exchanger 30 allows the seawater being desalinated to be injected into the evaporator chamber 17 at a higher temperature than previously known in the art without the application of an external source of heat. As previously stated, the temperature of the ambient seawater can be raised from about 8° C. (14.4° F.) to about 18° C. (32.4° F.) above its starting temperature due to the effect of the economizing heat exchanger 30. This serves to increase the efficiency and speed of seawater vaporization. By entering into the evaporator chamber 17 (which is in a vacuum) at a higher temperature, the incoming source seawater boils or evaporates into water vapor more quickly and vigorously.

Rather than or in addition to heating the evaporator 47 using an additional external source of heat, the present invention efficiently utilizes the heat remaining in the hot water utilized in the desorption cycle by directing all or a portion of such the fluid output from the adsorbent heat exchanger chambers 15 or 16 in the desorption cycle to the evaporator 47 through the evaporator-heating circuit 60. Returning to our example of source seawater at 15° C. (60° F.), the heating fluid enters the adsorbent heat exchanger chamber in the desorbing cycle (shown in FIG. 1 as chamber 16) through portion 23b at a temperature of about 90° C. (194° F.). In the desorbing process, a portion of the heat from the heating fluid is transferred to the adsorbate (water) in the adsorbent (silica gel 11), and the heating fluid exits the adsorbent heat exchanger chamber 16 at a temperature of about 85° C. (186° F.). Rather than returning this still hot fluid directly to the heat source (not shown), it can be directed to the evaporator-heating circuit 60 to drive the evaporator 47. The operation of the evaporator 47 utilizing the heating fluid having a temperature of above about 85° C. (186° F.) creates a temperature gap between the pre-heating incoming source seawater and the evaporator 47, further catalyzing vaporization of the incoming source seawater. After exiting the evaporator 47, the heating fluid has been further cooled from about 85° C. (186° F.) to about 78° C. (172° F.). After exiting the evaporator chamber 17, the heating fluid is returned to an external heat source (not shown) to be reheated.

Because of the operation of the evaporator 47 at higher temperatures, a mist eliminator 12 is interposed between the evaporator chamber 17 and the adsorbent heat exchanger chambers 15, 16, preferably between the evaporator 47 and the valves 19a, 19b that communicate between the evaporator chamber 17 and the adsorbent heat exchanger chambers 15, 16. The mist eliminator 12 functions to prevent passage of water droplets from passing from the evaporator chamber 17 into the adsorbent heat exchanger chambers 15, 16 and to collect water droplets from an air stream and divert the liquid to an appropriate drain 13 for return to the evaporator 12. In practice, performance of the adsorption-desalination unit 10 may be optimized by mathematically determining optimum parameters of adsorbent mass, adsorption/desorption cycle time, heating fluid flow and cooling fluid flow for loading into the programmable logic control system.

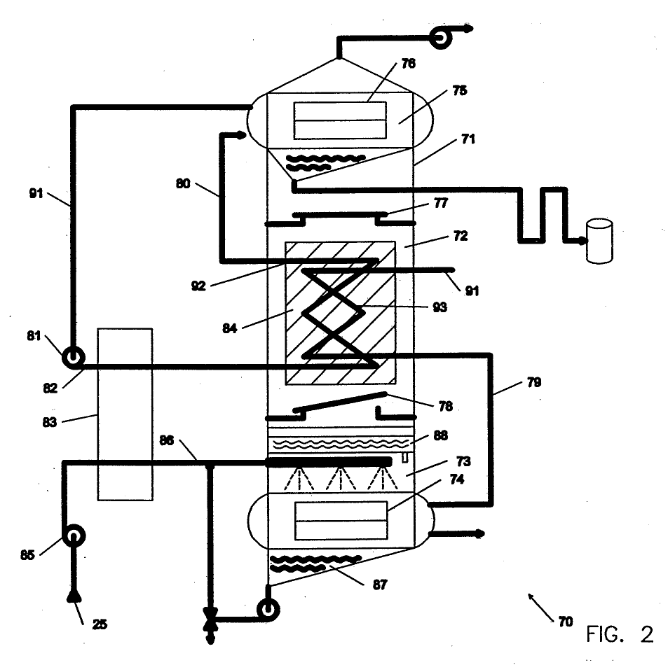

FIG. 2 illustrates an alternative embodiment of a single-cycle adsorption-desalination unit 70 according to the present invention comprising a pressure vessel 71, divided into a plurality of chambers, said chambers comprising an adsorbent heat exchanger chamber 72, located between an evaporator chamber 73 containing an evaporator 74 and a condenser chamber 75 containing a condenser 76. The adsorbent heat exchanger chamber 72 is connected to the condenser chamber 75 by one or more one-way valves 77 and to the evaporator chamber 73 by one or more one-way valves 78.

The single-cycle adsorption-desalination unit 70 further comprises a fluid circulation system 91 comprising interconnected tubing or piping to carry fluid to the different chambers 72, 73, and 75. Appropriate valves in the circulation system 91 are provided to selectively direct hot and cold fluid (typically water) through different sections or portions of the fluid circulation system 91 in the appropriate sequence to drive the adsorption process. Fluid circulation system 91 comprises adsorption heat exchanger circuit 92, cooling-water circuit 80, and evaporator-heating circuit 79. Adsorption heat exchanger circuit 92 further comprises portion 93 passing through adsorbent heat exchanger chamber 72. Cooling-water circuit 80 passes through the condenser chamber 75 to drive the condenser 76. Evaporator-heating circuit 79 passes through the evaporator chamber 73 to drive the evaporator 74. Fluid circulation system 91 further comprises an economizing heat exchanger loop 82 for passing fluid through an economizing heat exchanger 83. The economizing heat exchanger loop 82 comprises a portion of the cooling-water circuit 80 and is also interconnected with the adsorption heat exchanger circuit 92.

The fluid circulation system 91 further comprises a pumping means for moving the fluid through the circuit. Pumping means may comprise one or more pumps 81.

The portion 93 of adsorption heat exchanger circuit 92 within adsorbent heat exchanger chamber 72 is packed with an adsorbent 84, preferably silica gel.

The incoming source seawater is carried, such as by a pumping means like pump 85, from the source 25, through an inlet line 86 and into the evaporator chamber 73, where it is evaporated into a pure or distilled water vapor. This leaves behind the salt and other impurities in a more concentrated brine in the collection area 87 where it may be removed and reintroduced into the inlet line 86 or discarded as waste.

The inlet line 86 passes the incoming seawater through an economizing heat exchanger 83 for pre-heating. The cooling-water circuit 80 also passes through the economizing heat exchanger 83.

A mist eliminator 88 is interposed between the evaporator chamber 73 and the adsorbent heat exchanger chamber 72.

In operation, a single-cycle adsorption-desalination unit 70 can be switched between the adsorption cycle and the desorption cycle. The Programmable logic control system (not shown) can be appropriately programmed to control the plumbing to start, stop or otherwise manage the flows of source seawater and hot, cool and cold water throughout the various circuits and portions of the fluid circulation system 91 to optimize performance of the single-cycle adsorption-desalination unit 70.

In practice, two or more single-cycle adsorption-desalination units 70 can be operated in parallel, making the system scalable over multiple units 70 to increase the rate and volume of seawater desalinated. Because there is only an adsorbent heat exchanger chamber 72 within a single-cycle adsorption-desalination unit 70, such units 70 are less complicated and expensive to manufacture and thus may present a cost savings over the standard adsorption-desalination unit 10 (shown in FIG. 1) when the method of the present invention is practiced on an industrial scale.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

Having thus set forth the nature of the invention, we claim:

1. A device for desalinating seawater comprising:
(a) a pressure vessel divided into at least an evaporator chamber, a condenser chamber and at least one adsorbent heat exchanger chamber, wherein the evaporator chamber is connected to the adsorbent heat exchanger chamber by one or more valves, and wherein the condenser chamber is connected to the adsorbent heat exchanger chamber by one or more valves;
(b) a fluid circulation system to selectively direct relatively hot or relatively cold fluid through a portion of said fluid circulation system within the adsorbent heat exchanger chamber;
(c) an adsorbent which can be regenerated, said adsorbent surrounding said portions of said fluid circulation system within the adsorbent heat exchanger chamber;
(d) an evaporator within the evaporator chamber;
(e) a condenser within the condenser chamber;
(f) an inlet line for introducing the seawater into the evaporator chamber; and
(g) an economizing heat exchanger for transferring heat arising out of adsorption taking place within the adsorbent heat exchanger chamber to seawater in the inlet line.

2. The device for desalinating seawater of claim 1 wherein the pressure vessel is divided into at least two adsorbent heat exchanger chambers.

3. The device for desalinating seawater of claim 1 wherein the economizing heat exchanger raises the temperature of seawater in the inlet line from between about 8° C. to about 18° C. above the temperature at which it enters the economizing heat exchanger.

4. The device for desalinating seawater of claim 1 wherein said fluid circulation system further comprises an economizing heat exchanger loop for passing fluid through the economizing heat exchanger.

5. The device for desalinating seawater of claim 4 wherein the adsorbent heat exchanger chamber alternately cycles through an adsorption cycle and a desorption cycle and fluid is passed through the portion of the fluid circulation system within the adsorbent heat exchanger chamber in the adsorption cycle prior to being passed through the economizing heat exchanger loop.

6. The device for desalinating seawater of claim 4 wherein said fluid circulation system further comprises a cooling-water circuit passing through the condenser and wherein fluid is passed through the cooling-water circuit prior to being passed through the economizing heat exchanger loop.

7. The device for desalinating seawater of claim 4 wherein the adsorbent heat exchanger chamber alternately cycles through an adsorption cycle and a desorption cycle and wherein said fluid circulation system further comprises a cooling-water circuit passing through the condenser and wherein fluid is passed through the portion of the fluid circulation system within the adsorbent heat exchanger chamber in the adsorption cycle, then through the cooling-water circuit, then through the economizing heat exchanger loop.

8. The device for desalinating seawater of claim 1 wherein the adsorbent heat exchanger chamber alternately cycles through an adsorption cycle and a desorption cycle and wherein said fluid circulation system further comprises an evaporator-heating circuit passing through the evaporator and wherein fluid is passed through the portion of the fluid circulation system within the adsorbent heat exchanger chamber in the desorption cycle prior to being passed through the evaporator-heating circuit.

9. The device for desalinating seawater of claim 1 further comprising a mist eliminator intermediate the evaporator and the adsorbent heat exchanger chambers.

10. A device for desalinating seawater comprising:
(a) a pressure vessel divided into at least an evaporator chamber, a condenser chamber and an adsorbent heat exchanger chamber, wherein the evaporator chamber is connected to the adsorbent heat exchanger chamber by one or more valves, and wherein the condenser chamber is connected to the adsorbent heat exchanger chamber by one or more valves;
(b) a fluid circulation system to selectively direct hot or cold fluid through a portion of said fluid circulation system within the adsorbent heat exchanger chamber;
(c) an adsorbent which can be regenerated, said adsorbent surrounding said portions of said fluid circulation system within each of the adsorbent heat exchanger chambers;
(d) an evaporator within the evaporator chamber;
(e) a condenser within the condenser chamber; and
(f) a mist eliminator intermediate the evaporator and the adsorbent heat exchanger chamber.

11. The device for desalinating seawater of claim 10 further comprising two or more adsorbent heat exchanger chambers.

12. The device for desalinating seawater of claim 10 wherein the mist eliminator further comprises a tortured-path mist eliminator.

13. The device for desalinating seawater of claim 10 wherein the mist eliminator is positioned intermediate the evaporator and the valves connecting the evaporator chamber to the adsorbent heat exchanger chamber.

14. The device for desalinating seawater of claim 10 having an inlet line for introducing the seawater into the evaporator chamber and an economizing heat exchanger for transferring heat arising out of adsorption taking place within the adsorbent heat exchanger chamber to seawater in the inlet line.

15. The device for desalinating seawater of claim 14 wherein the fluid circulation system further comprises an economizing heat exchanger loop for passing fluid through the economizing heat exchanger.

16. The device for desalinating seawater of claim 15 wherein the adsorbent heat exchanger chamber alternately cycles through an adsorption cycle and a desorption cycle and fluid is passed through the portion of the fluid circulation system within the adsorbent heat exchanger chamber in the adsorption cycle prior to being passed through the economizing heat exchanger loop.

17. The device for desalinating seawater of claim 15 wherein the fluid circulation system further comprises a cooling-water circuit passing through the condenser and wherein fluid is passed through the cooling-water circuit prior to being passed through the economizing heat exchanger loop.

18. The device for desalinating seawater of claim 14 wherein the economizing heat exchanger raises the temperature of seawater in the inlet line from between about 8° C. to about 18° C. above the temperature at which it enters the economizing heat exchanger.

19. The device for desalinating seawater of claim 10 wherein the fluid circulation system further comprises an evaporator-heating circuit for passing fluid through the evaporator.

20. The device for desalinating seawater of claim 19 wherein the adsorbent heat exchanger chamber alternately cycles through an adsorption cycle and a desorption cycle and fluid is passed through the portion of the fluid circulation system within the adsorbent heat exchanger chamber in the desorption cycle prior to being passed through the evaporator-heating circuit.

21. A device for desalinating seawater comprising:
(a) a pressure vessel divided into at least an evaporator chamber, a condenser chamber and an adsorbent heat exchanger chamber, wherein the evaporator chamber is connected to the adsorbent heat exchanger chamber by one or more valves, and wherein the condenser chamber is connected to the adsorbent heat exchanger chamber by one or more valves;
(b) a fluid circulation system to selectively direct hot or cold fluid through a portion of said fluid circulation system within the adsorbent heat exchanger chamber;
(c) an adsorbent which can be regenerated, said adsorbent surrounding said portions of said fluid circulation system within the adsorbent heat exchanger chamber;
(d) an evaporator within the evaporator chamber;
(e) a condenser within the condenser chamber;
(f) wherein the isosteric heat of adsorption is used to raise the temperature of the seawater introduced into the evaporator chamber from between about 8° C. to about 18° C. above the ambient seawater temperature.

22. The device for desalinating seawater of claim 21 further comprising two or more adsorbent heat exchanger chambers.

23. The device for desalinating seawater of claim 21 wherein the adsorbent heat exchanger chamber alternately cycles through an adsorption cycle and a desorption cycle and wherein said fluid circulation system further comprises an evaporator-heating circuit passing through the evaporator and wherein fluid is passed through the portion of the fluid circulation system within the adsorbent heat exchanger chamber in the desorption cycle prior to being passed through the evaporator-heating circuit.

24. The device for desalinating seawater of claim 21 having an inlet line for introducing the seawater into the evaporator chamber and an economizing heat exchanger for transferring the isosteric heat of adsorption taking place within the adsorbent heat exchanger chamber to seawater in the inlet line.

25. The device for desalinating seawater of claim 24 wherein the fluid circulation system further comprises an economizing heat exchanger loop for passing fluid through the economizing heat exchanger.

26. The device for desalinating seawater of claim 25 wherein the adsorbent heat exchanger chamber alternately cycles through an adsorption cycle and a desorption cycle and fluid is passed through the portion of the fluid circulation system within the adsorbent heat exchanger chamber in the adsorption cycle prior to being passed through the economizing heat exchanger loop.

27. The device for desalinating seawater of claim 25 wherein the fluid circulation system further comprises a cooling-water circuit passing through the condenser and wherein fluid is passed through the cooling-water circuit prior to being passed through the economizing heat exchanger loop.

28. The device for desalinating seawater of claim 21 having a mist eliminator intermediate the evaporator and the adsorbent heat exchanger chamber.

29. A device for desalinating seawater comprising:
(a) a pressure vessel divided into at least an evaporator chamber, a condenser chamber and an adsorbent heat exchanger chamber, wherein the evaporator chamber is connected to the adsorbent heat exchanger chamber by one or more valves, and wherein the condenser chamber is connected to the adsorbent heat exchanger chamber by one or more valves, and wherein the adsorbent heat exchanger chamber alternately cycles through an adsorption cycle and a desorption cycle;
(b) a fluid circulation system to selectively direct hot or cold fluid through a portion of said fluid circulation system within the adsorbent heat exchanger chamber;
(c) an adsorbent which can be regenerated, said adsorbent surrounding said portions of said fluid circulation system within the adsorbent heat exchanger chamber;
(d) an evaporator within the evaporator chamber;
(e) a condenser within the condenser chamber; and
(f) wherein said fluid circulation system further comprises an evaporator-heating circuit passing through the evaporator for directing fluid exiting the portion of the fluid circulation system within the adsorbent heat exchanger chamber in the desorption cycle though the evaporator.

30. The device for desalinating seawater of claim 29 wherein the isosteric heat of adsorption is used to raise the temperature of the seawater introduced into the evaporator chamber from between about 8° C. to about 18° C. above the ambient seawater temperature.

31. The device for desalinating seawater of claim 29 further comprising two or more adsorbent heat exchanger chambers.

32. The device for desalinating seawater of claim 29 having an inlet line for introducing the seawater into the evaporator chamber and an economizing heat exchanger for transferring the isosteric heat of adsorption taking place within the adsorbent heat exchanger chamber to seawater in the inlet line.

33. The device for desalinating seawater of claim 32 wherein the fluid circulation system further comprises an economizing heat exchanger loop for passing fluid through the economizing heat exchanger.

34. The device for desalinating seawater of claim 33 wherein the adsorbent heat exchanger chamber alternately cycles through an adsorption cycle and a desorption cycle and fluid is passed through the portion of the fluid circulation system within the adsorbent heat exchanger chamber in the adsorption cycle prior to being passed through the economizing heat exchanger loop.

35. The device for desalinating seawater of claim 32 wherein the fluid circulation system further comprises a cooling-water circuit passing through the condenser and wherein fluid is passed through the cooling-water circuit prior to being passed through the economizing heat exchanger loop.

36. The device for desalinating seawater of claim 29 having a mist eliminator intermediate the evaporator and the adsorbent heat exchanger chamber.

37. A method of desalinating source seawater comprising the steps of:
(a) Adding heat to a cooling fluid by an adsorption process;
(b) transferring said heat from said cooling fluid to source seawater;
(c) injecting heated source seawater into an evaporator;
(d) evaporating seawater within the evaporator into water vapor;
(e) passing water vapor from the evaporator to an adsorbent heat exchanger chamber;
(f) reversibly adsorbing the water vapor from the evaporator into an adsorbent, thereby increasing the temperature of the cooling fluid;
(g) reversibly desorbing the water vapor from the adsorbent;
(h) drawing water vapor from the adsorbent heat exchanger chamber to a condenser;
(i) condensing the water vapor to form desalinated water.

38. The method of desalinating seawater of claim 37 wherein the temperature of the source seawater is raised in such transferring heat step from between about 8° C. to about 18° C. above its ambient temperature.

39. The method of desalinating seawater of claim 37 wherein the step of passing water vapor from the evaporator to an adsorbent heat exchanger chamber further comprises pulling the water vapor through a mist eliminator.

40. The method of desalinating seawater of claim 37 further comprising the step of utilizing residual heat remaining in a heating fluid used to drive the desorbing step to heat the evaporator.
